(19) United States
(12) Patent Application Publication
(10) Pub. No.: US 2025/0162680 A1
(43) Pub. Date: May 22, 2025

(54) HANDLEBAR GRIP ASSEMBLIES

(71) Applicant: Extreme Steering, Inc., Chino Valley, AZ (US)

(72) Inventor: Gary Stewart, Prescott, AZ (US)

(73) Assignee: Extreme Steering, Inc., Chino Valley, AZ (US)

(21) Appl. No.: 18/511,955

(22) Filed: Nov. 16, 2023

(51) Int. Cl. B62K 21/26; F16B 2/06

(52) U.S. Cl. CPC B62K 21/26; F16B 2/065

(57) ABSTRACT

A handlebar grip assembly includes an inner tube defining first and second inner tube longitudinal ends and an inner tube length, and including a wall, a first slit adjacent to the first inner tube longitudinal end that extends through the wall, and a second slit adjacent to the second inner tube longitudinal end that extends through the wall, and a handlebar grip, defining first and second grip longitudinal ends and a grip length that is less than the inner tube length, on the inner tube such that the first and second grip longitudinal ends are between the first and second inner tube longitudinal ends.

### BACKGROUND

### 1. Field

The present inventions relate generally to handlebar grips including, but not limited to, bicycle handlebar grips.

### 2. Description of the Related Art

Handlebar grips are used to make gripping handlebars more comfortable, to prevent the rider's hands from slipping, to improve the rider's grip on the handlebar, and to damp vibrations. As such, the grips are commonly formed from relatively soft materials such as, for example, silicone, rubber, and foam rubber. It is also desirable that grips remain in place on the handlebar, and do not rotate relative to the handlebar, after being mounted onto the handlebar. To that end, the inner diameter of the grips is typically slightly less than the outer diameter of the associated portions of the handlebars and the relatively high coefficient of friction between the grips and the handlebars is sufficient to maintain the grips in their intended location and prevent rotation during use.

Although conventional relatively soft handlebar grips are quite useful, the present inventor has determined that they are susceptible to improvement. For example, due the relatively high coefficient of friction between grips and handlebars, it can be difficult to mount the grips onto a handlebar and to remove grips at the time of replacement. One proposed solution is to mold a handlebar grip onto a plastic tube which has protrusions that mechanically interlock with the grip material. The tube/grip combination slides onto a handlebar and is held in place by a pair of circular clamps that are typically sold to end users with the tube/grip combination. Circumferentially spaced protrusions at each longitudinal end of the circular tube are clamped against the handlebar, while the majority of each clamp is in contact with the handlebar. The present inventor has determined that this proposed solution is susceptible to improvement. For example, the clamp/handlebar contact can result in damage to the handlebar. Additionally, the inner diameter of the plastic tube must be slightly larger than the outer diameter of the handlebar to facilitate the sliding of the tube/grip combination onto the handlebar, which can lead to post-clamping gaps between the tube and the handlebar that extend along the length of the tube in regions between the protrusions. This reduces the effectiveness of the clamp and increases the likelihood of rotation of tube/grip combination on the handlebar. Another issue stems from the fact that the relatively hard clamps extend outwardly father than the relatively soft grips, which leads to rider discomfort when portions the riders' palms are positioned over the clamps.

### SUMMARY

A handlebar grip assembly in accordance with one embodiment of a present invention includes an inner tube defining first and second inner tube longitudinal ends and an inner tube length, and including a wall, a first slit adjacent to the first inner tube longitudinal end that extends through the wall, and a second slit adjacent to the second inner tube longitudinal end that extends through the wall, and a handlebar grip, defining first and second grip longitudinal ends and a grip length that is less than the inner tube length, on the inner tube such that the first and second grip longitudinal ends are between the first and second inner tube longitudinal ends. The present inventions also include handlebar assemblies that include such handlebar grip assemblies and a handlebar.

A handlebar grip assembly in accordance with one embodiment of a present invention includes an inner tube including a wall and defining first and second inner tube longitudinal ends, an inner tube length and first and second exposed portions adjacent to the first and second inner tube longitudinal ends, each of the first and second exposed portions having circumferentially-spaced tube indentations that are separated by tube protrusions, a handlebar grip, defining first and second grip longitudinal ends and a grip length that is less than the inner tube length, on the inner tube such that the first and second grip longitudinal ends are between the first and second exposed portions, and first and second clamps defining respective inner surfaces and each including a plurality of clamp projections that are on the inner surface and are configured to fit within the circumferentially spaced tube indentations and a plurality of clamp indentations that are on the inner surface and are configured to receive the circumferentially spaced tube projections. The present inventions also include handlebar assemblies that include such handlebar grip assemblies and a handlebar.

A handlebar grip assembly in accordance with one embodiment of a present invention includes an inner tube defining an inner tube length, first and second exposed portions and first and second inner tube longitudinal ends, a handlebar grip, defining first and second grip longitudinal ends and a length that is less than the inner tube length, on the inner tube such that the first and second grip longitudinal ends are between the first and second tube longitudinal ends, and first and second clamps associated with the first and second exposed portions of the inner tube and each defining respective longitudinal axes and thicknesses in directions perpendicular to the longitudinal axes that are different in at least two locations. The present inventions also include handlebar assemblies that include such handlebar grip assemblies and a handlebar.

The above described and many other features of the present inventions will become apparent as the inventions become better understood by reference to the following detailed description when considered in conjunction with the accompanying drawings.

### BRIEF DESCRIPTION OF THE DRAWINGS

Detailed description of embodiments of the inventions will be made with reference to the accompanying drawings.

FIG. 1 is a side view of a handlebar grip assembly in accordance with one embodiment of a present invention.

FIG. 2 is an exploded side view of the handlebar grip assembly illustrated in FIG. 1.

FIG. 3 is a partially exploded top view of a handlebar assembly including a handlebar and two of the handlebar grip assemblies illustrated in FIG. 1.

FIG. 4 a plan view of a portion of the handlebar grip assembly illustrated in FIG. 1.

FIG. 5 is a perspective view of a portion of the handlebar grip assembly illustrated in FIG. 1.

FIG. 6 is an end view of a portion of the handlebar grip assembly illustrated in FIG. 1.

FIG. 7 is an end view of a portion of the handlebar grip assembly illustrated in FIG. 1.

FIG. 8 is a side view of a portion of the handlebar grip assembly illustrated in FIG. 1.

FIG. 9 is an exploded perspective view of a portion of the handlebar grip assembly illustrated in FIG. 1.

FIG. 10 is a partial perspective view of the handlebar grip assembly illustrated in FIG. 1.

FIG. 11 is a partial side view of the handlebar grip assembly illustrated in FIG. 1.

FIG. 12 is a partial perspective view of the handlebar grip assembly illustrated in FIG. 1.

FIG. 13 is a partial side view of the handlebar grip assembly illustrated in FIG. 1.

FIG. 14 is a partial side view of the handlebar grip assembly illustrated in FIG. 1.

FIG. 15 is an end view of a handlebar assembly including a handlebar and the handlebar grip assembly illustrated in FIG. 1.

FIG. 16 is a plan view of a portion of the handlebar grip assembly illustrated in FIG. 1.

### DETAILED DESCRIPTION

The following is a detailed description of the best presently known modes of carrying out the inventions. This description is not to be taken in a limiting sense, but is made merely for the purpose of illustrating the general principles of the inventions.

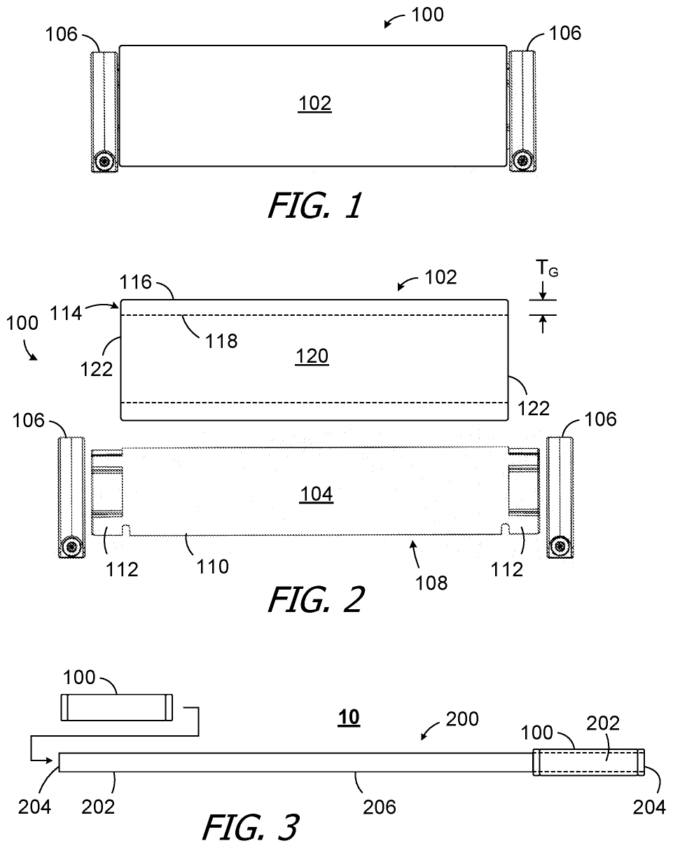

As illustrated for example in FIGS. 1 and 2, a handlebar grip assembly 100 in accordance with one embodiment of a present invention may include a handlebar grip 102 (also referred to herein as “grip 102” or “grip”), an inner tube 104, and a pair of clamps 106. The inner tube 104, which may include a tubular wall 108, has a covered portion 110 on which the grip 102 is mounted (e.g., by press fitting or molding) and exposed portions 112 on which the clamps 106 are mounted when the handlebar grip assembly 100 is in an assembled state. A pair of handlebar grip assemblies 100 may be mounted on a handlebar 200 in the manner illustrated in FIG. 3 to form a handlebar assembly 10. The exemplary handlebar 200 includes end portions 202, with respective longitudinal ends 204, and a center region 206 that may be connected to a stem (or other structure) that connects the handlebar to the forks. The handlebar grip assemblies 100 are mounted on the end portions 202. The handlebar 200 may be straight (as shown), curved, or any other handlebar configuration. The clamps 106 compress the exposed portions 112 of the inner tube 104 against the end portions 202, thereby preventing axial and rotational movement of the grip assemblies 100 relative to the handlebar 200 without directly contacting the handlebar.

The exemplary handlebar grip 102 includes a tube-shaped wall 114 with an outer surface 116 and an inner surface 118 that defines a lumen 120. The grip 102 has longitudinal ends 122 and is a solid, continuous tube with a wall thickness T_{G} in the illustrated implementation.

Inner tubes in accordance with the present inventions may, in some implementations, be configured to facilitate compression of the exposed portions. Alternatively, or in addition, inner tubes and clamps in accordance with the present inventions may, in some implementations, be respectively configured to prevent rotation of the clamps relative to the associated inner tube. Alternatively, or in addition, inner tubes and clamps in accordance with the present inventions may, in some implementations, be respectively configured to prevent the clamps moving axially beyond a predetermined location on the inner tube. In the illustrated implementation, the inner tube and clamps are configured to provide all three of these functionalities.

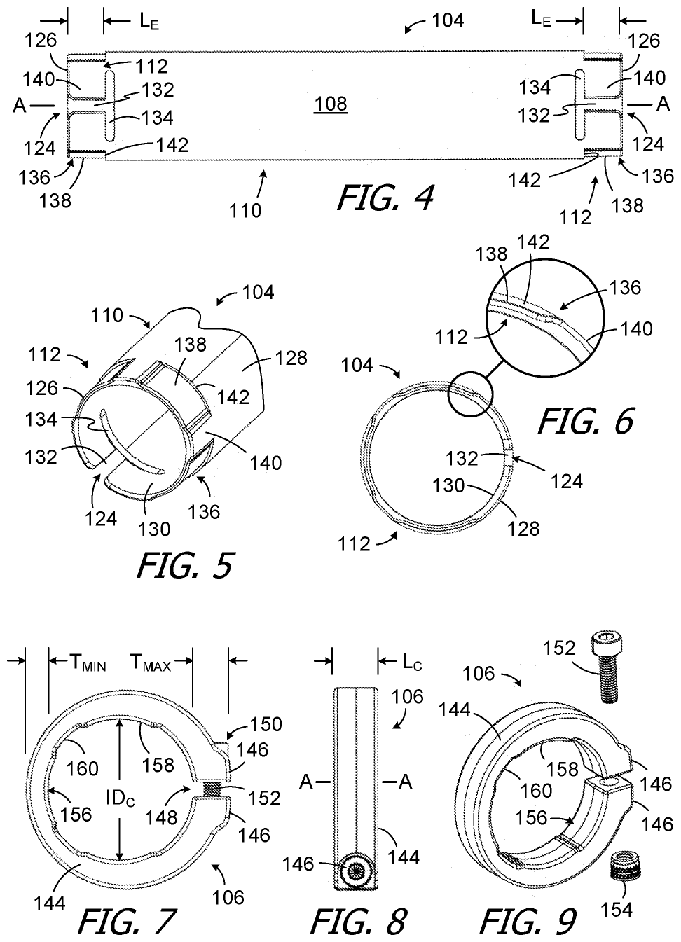

To that end, and referring to FIGS. 4-6, the exemplary inner tube 104 includes a pair of slits 124 that are respectively associated with the longitudinal ends 126 of the inner tube. The slits 124 extend completely through the tubular wall 108, from the outer surface 128 to the inner surface 130, and greatly increase the compressibility of the exposed portions 112 as compared to an otherwise identical tube without the slits. The inner tube 104 defines a longitudinal axis A-A and the exemplary slits 124 are T-shaped include an axially extending portion 132 and a circumferentially extending portion 134. Although not so limited, the axially extending portions 132 extend the full width of the exposed portions 112 and the circumferentially extending portions 134 are located at the lateral ends of the covered portion 110. There are no slits (or portions of slits) between in the tubular wall 108 between the circumferentially extending portions 134.

It should be noted here that the slits are not limited to the exemplary shape and number described above with reference to FIGS. 4-6. By way of example, but not limitation, there may be more than one slit at one end or both ends of the inner tube. Alternatively, or in addition, the shape of the slits may be different. For example, one or more slits may be an L-shape or may only consist of an axially extending portion.

Regardless of configuration, each of the slits 124 may be configured in such a manner that they do not extend into the inner tube covered portion 110 or extend only a relatively short distance into the covered portion (as shown). As used herein, a “relatively short distance” means no more than 0.25 inch or no more than 6% of the length of the covered portion. Such a slit configuration, in combination with a tight fit between the grip 102 and the inner tube 104, reduces the likelihood (as compared to a slit that is longer and/or that extends from one end of the inner tube to the other) that there will be moisture between the grip and inner tube as well as the moisture-associated increase in the likelihood that the grip will rotate relative to the inner tube.

With respect to the manner in which the clamps 106 are secured to the inner tube 104 in the exemplary embodiment, the exemplary clamps and the exemplary inner tube exposed portions 112 have complimentary interlocking members that prevent clamp rotation around the inner tube axis A-A relative to the inner tube and limit axial movement of the clamps relative to the inner tube. Referring first to the inner tube 104, and as illustrated for example in FIGS. 4-6, the outer surfaces of the exposed portions 112, which define lengths L_{E} in the axial direction, each include an interlock member 136 with a plurality of circumferentially-spaced indentations 138 that are separated by protrusions 140. The wall thickness at the protrusions 140 may be the same as (as shown), less than, or greater than the wall thickness of the covered portion 110. A plurality of stops 142, which limit axial movement of the clamps 106 in the manner described below with reference to FIGS. 10-13, are defined by the closed ends of the indentations 138.

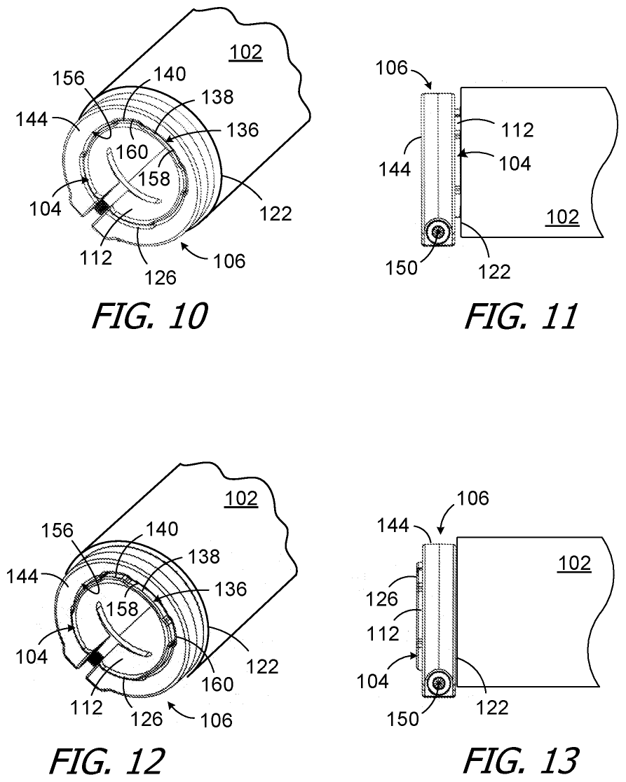

Turning to FIGS. 7-9, the exemplary clamps 106 include a C-shaped clamp body 144 with free ends 146 that are separated by a gap 148 as well as a tightener 150 with a threaded bolt 152 and a threaded anchor 154. The clamps 106 also define an axis A-A and a length L_{c} in the axial direction. Rotation of the threaded bolt 152 causes the free ends 146 to move towards and away from one another to tighten and loosen the clamp 106. The inner surface of each clamp 106 includes an interlock member 156 with a plurality of circumferentially-spaced protrusions 158 that are separated by indentations 160.

The configurations of the exemplary interlock members 136 and 156, i.e., the respective sizes, shapes and locations of the indentations 138 and 160 and the protrusions 140 and 158, are such that rotation of the clamps 106 relative to the inner tube 104 is prevented. In particular, rotation of the clamps 106 relative to the inner tube 104 generally, and rotation of the clamps relative to the exposed portions 112 in particular, is prevented when the protrusions 140 and 158 are located within the indentations 138 and 160 as shown in FIGS. 10-13. It should also be noted here that the length L_{c} (FIG. 8) of the clamps 106 is slightly less than the length L_{E} (FIG. 4) of the exposed portions 112. As a result, the clamps 106 may, for example, be aligned with the inner tube longitudinal ends 126 and spaced from the grip longitudinal ends 122, as shown in FIGS. 10 and 11. The clamps 106 may also, for example, be spaced apart from the inner tube longitudinal ends 126 and pressed against the grip longitudinal ends 122, as shown in FIGS. 12 and 13.

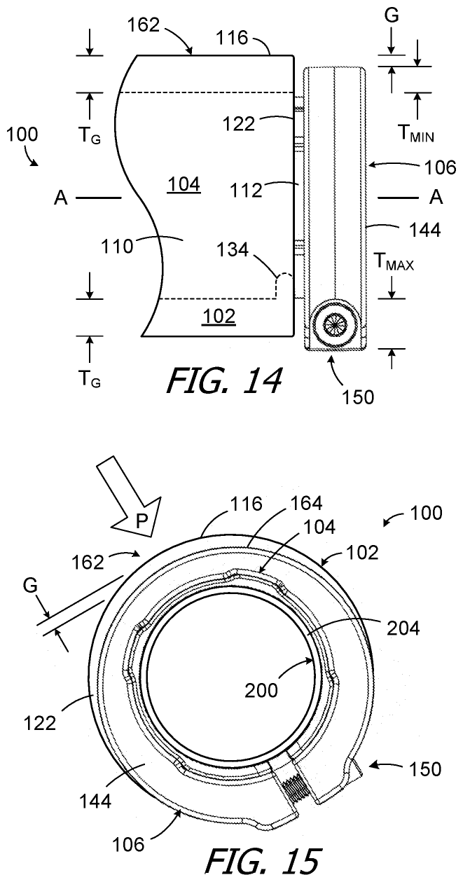

Grip assemblies in accordance with at least some of the present inventions may also be configured in such a manner that the palms of the riders' hands are less likely to come into contact with the relatively hard clamps 106, thereby preventing the discomfort associated with the palms resting on the clamps during a ride. Referring first to FIGS. 7 and 8, the exemplary clamp body 144 has a thickness (measured in a direction perpendicular to the longitudinal axis A-A) that varies. The clamp thickness varies from a maximum T_{MAX} at the free ends 146 to a minimum T_{MIN} at a location on the opposite side of the clamp body 144, i.e. a location that is offset by about 180 degrees from the free ends. Referring to FIGS. 14 and 15, the thickness T_{G} of the grip wall 114 in the illustrated implementation is greater than the clamp body minimum thickness T_{MIN} and is less than the clamp body maximum thickness T_{MAX}. This results in a grip region 162 where the outer surface 116 of the grip 102 is radially outward of the outer surface 164 of the clamps 106, which results in the presence of a gap G. The grip assembly 100 may be rotationally oriented on the handlebar 200 such that grip region 162 faces the intended palm location (note arrow P) of the rider. In those instances where the end of a rider's palm is located over the clamp 106, the presence of the gap G will limit the amount of pressure that the palms exert on the clamps 116 as well as the associated discomfort.

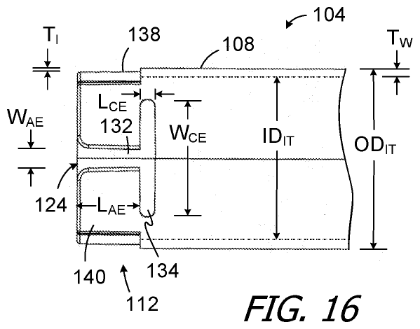

With respect to dimensions, and although the present inventions are not so limited, the dimension of various elements of the exemplary handlebar assembly 100 may be as follows. The exemplary dimensions are presented in the context of a handlebar 200 with an outer diameter that is about 0.875 inch and may be adjusted as necessary to accommodate different handlebar outer diameters. The wall thickness T_{G} of the grip 102 may range from about 0.120 inch to about 0.250 inch and is 0.180 inch the illustrated embodiment. As used herein in the context of dimensions, the word “about” mean ±10%. Turning to the inner tube 104, the inner diameter ID_{IT} may range from about 0.878 inches to about 0.895 inch and is 0.888 inch in the illustrated embodiment, which allows the inner tube to slide onto the handlebar 200, and the outer diameter OD_{IT} may range from about 0.990 inch to about 1.010 inch and is 1.000 inch in the illustrated embodiment. The thickness T_{w} of the tubular wall 108 (and protrusions 140) may range from about 0.052 inch to about 0.062 inch and is 0.057 inch in the illustrated embodiment, while the thickness T_{I} of the indentations 138 may range from about 0.019 inch to about 0.025 inch and is 0.022 inch in the illustrated embodiment. The overall length of the inner tube 104 (from one longitudinal end 126 to the other) may range from about 4.0 inches to about 6.0 inches and is 5.140 inches in the illustrated embodiment, while the length L_{E} of exposed portions 112 may range from about 0.330 inch to about 0.370 inch and is 0.35 inch in the illustrated embodiment. With respect to the exemplary slits 124, and referring to FIG. 16, the axially extending portion 132 may have a length L_{AE} that ranges from about 0.340 inch to about 0.360 inch and is 0.35 inch in the illustrated embodiment and a width W_{AE} that ranges from about 0.089 inch to about 0.120 inch and is 0.10 inch in the illustrated embodiment, while the circumferentially extending portion 134 may have a length L_{CE} that ranges from about 0.070 inch to about 0.090 inch and is 0.080 inch in the illustrated embodiment and a width W_{CE} that ranges from about 0.600 inch to about 0.700 inch and is 0.65 inch in the illustrated embodiment. With respect to the clamps 106 (FIGS. 7-9), the minimum thickness T_{MIN} of the clamp bodies 144 may range from about 0.135 inch to about 0.155 inch and is 0.145 inch in the illustrated embodiment, the maximum thickness T_{MAX} of the clamp bodies may range from about 0.240 inch to about 0.270 inch and is 0.260 inch in the illustrated embodiment, and the length L_{c} of the clamp bodies may range from about 0.285 inch to about 0.350 inch and is 0.300 inch in the illustrated embodiment. When in an unstressed state, the inner diameter ID_{c} of the clamp body 144, measured at the protrusions 158, may range from about 0.930 inch to about 0.950 inch and is 0.940 inch in the illustrated embodiment.

With respect to materials, suitable materials for the handlebar grip 102 include, but are not limited to, silicone, such as closed cell silicone sponge in accordance with Aerospace Material Specifications (AMS) D3195, rubber, foam rubber, and the like. Suitable materials for the inner tube 104 include, but are not limited to, polypropylene, which facilitate compression of the exposed portions 112. One advantage of the exemplary grip and inner tube materials is that there is a relatively high coefficient of friction between the grip 102 and the inner tube 104, which reduces the likelihood that the grip will rotate relative to the inner tube. Turning to the exemplary clamps 106, the clamp bodies 144 may be molded from carbon fiber reinforced nylon, with a brass anchor 154 inserted into the mold, or may be machined from aluminum or other metal.

Although the present inventions have been described in terms of the preferred embodiments above, numerous modifications and/or additions to the above-described preferred embodiments would be readily apparent to one skilled in the art. It is intended that the scope of the present inventions extend to all such modifications and/or additions.

1. A handlebar grip assembly, comprising:
an inner tube defining first and second inner tube longitudinal ends and an inner tube length, and including a wall, a first slit adjacent to the first inner tube longitudinal end that extends through the wall, and a second slit adjacent to the second inner tube longitudinal end that extends through the wall; and
a handlebar grip, defining first and second grip longitudinal ends and a grip length that is less than the inner tube length, on the inner tube such that the first and second grip longitudinal ends are between the first and second inner tube longitudinal ends.

2. A handlebar grip assembly as claimed in claim 1, wherein
the inner tube defines an axial direction and a circumference; and
the first and second slits each include a portion that extends in the axial direction and a portion that extends partially around the circumference.

3. A handlebar grip assembly as claimed in claim 2, wherein
the first and second slits are T-shaped.

4. A handlebar grip assembly as claimed in claim 1, further comprising:
first and second clamps that are configured to clamp the inner tube to a handlebar.

5. A handlebar grip assembly as claimed in claim 4, wherein
the inner tube has a first exposed portion that extends from the first grip longitudinal end to the first tube longitudinal end and defines a first exposed portion length, and a second exposed portion that extends from the second grip longitudinal end to the second tube longitudinal end and defines a second exposed portion length;
at least a portion of the first slit is located within the first exposed portion and at least a portion of the second slit is located within the second exposed portion; and
the first and second clamps are configured to be positioned over the first and second exposed portions of the inner tube.

6. A handlebar grip assembly as claimed in claim 5, wherein
the first and second clamps define respective clamp lengths that are less than the first and second exposed portion lengths.

7. A handlebar grip assembly as claimed in claim 5, wherein
the first and second exposed portions include stops that limit axial movement of the first and second clamps.

8. A handlebar grip assembly as claimed in claim 5, wherein
the inner tube defines an outer surface, an inner surface and a circumference, and the outer surfaces of the first and second exposed portions include respective pluralities of circumferentially spaced tube indentations; and
the first and second clamps define respective inner surfaces with pluralities of circumferentially spaced clamp projections that are configured to fit within the circumferentially spaced tube indentations.

9. A handlebar grip assembly as claimed in claim 5, wherein
the slits extend no more than a relatively short distance into the covered portion of the inner tube.

10. A handlebar grip assembly as claimed in claim 1, wherein
the first and second clamps define respective longitudinal axes and thicknesses in a direction perpendicular to the longitudinal axes; and
the thicknesses of the first and second clamps in at least one location is different than the thicknesses in at least one other location.

11. A handlebar grip assembly, comprising:
an inner tube including a wall and defining first and second inner tube longitudinal ends, an inner tube length and first and second exposed portions adjacent to the first and second inner tube longitudinal ends, each of the first and second exposed portions having circumferentially-spaced tube indentations that are separated by tube protrusions;
a handlebar grip, defining first and second grip longitudinal ends and a grip length that is less than the inner tube length, on the inner tube such that the first and second grip longitudinal ends are between the first and second exposed portions; and
first and second clamps defining respective inner surfaces and each including a plurality of clamp projections that are on the inner surface and are configured to fit within the circumferentially spaced tube indentations and a plurality of clamp indentations that are on the inner surface and are configured to receive the circumferentially spaced tube projections.

12. A handlebar grip assembly as claimed in claim 11, wherein
the inner tube includes a first slit adjacent to the first tube longitudinal end that extends through the wall, and a second slit adjacent to the second tube longitudinal end that extends through the wall.

13. A handlebar grip assembly as claimed in claim 12, wherein
the inner tube defines an axial direction and a circumference; and
the first and second slits each include a portion that extends in the axial direction and a portion that extends partially around the circumference.

14. A handlebar grip assembly as claimed in claim 11, wherein
the first and second exposed portions define respective exposed portion lengths; and
the first and second clamps define respective clamp lengths that are less than the first and second exposed portion lengths.

15. A handlebar grip assembly as claimed in claim 11, wherein
the first and second clamps define respective longitudinal axes and thicknesses in directions perpendicular to the longitudinal axes; and
the thicknesses of the first and second clamps in at least one location is different than the thicknesses in at least one other location.

16. A handlebar grip assembly, comprising:
an inner tube defining an inner tube length, first and second exposed portions and first and second inner tube longitudinal ends;
a handlebar grip, defining first and second grip longitudinal ends and a length that is less than the inner tube length, on the inner tube such that the first and second grip longitudinal ends are between the first and second tube longitudinal ends; and
first and second clamps associated with the first and second exposed portions of the inner tube and each defining respective longitudinal axes and thicknesses in directions perpendicular to the longitudinal axes that are different in at least two locations.

17. A handlebar grip assembly as claimed in claim 16, wherein
the first and second clamps each define a maximum clamp thickness and a minimum clamp thickness that is offset from the maximum clamp thickness by about 180 degrees around the longitudinal axis.

18. A handlebar grip assembly as claimed in claim 16, wherein
the handlebar grip includes a wall defining a grip wall thickness; and
the first and second clamps each define a maximum clamp thickness and a minimum clamp thickness, and the minimum clamp thickness is less than the grip wall thickness.

19. A handlebar grip assembly as claimed in claim 18, wherein
the maximum clamp thickness of the first and second clamps is greater than the grip wall thickness.

20. A handlebar grip assembly as claimed in claim 16, wherein
the first and second exposed portions each include circumferentially-spaced tube indentations and circumferentially-spaced tube protrusions; and
the first and second clamps each define respective inner surfaces with circumferentially-spaced clamp protrusions that are configured to fit within the circumferentially-spaced tube indentations and circumferentially-spaced clamp indentations that are configured to receive the circumferentially spaced tube projections.

21. A handlebar grip assembly as claimed in claim 16, wherein
the inner tube includes a wall, a first slit adjacent to the first tube longitudinal end that extends through the wall, and a second slit adjacent to the second tube longitudinal end that extends through the wall.

22-24. (canceled)
